(19) United States
(12) Patent Application Publication
(10) Pub. No.: US 2010/0302332 A1
(43) Pub. Date: Dec. 2, 2010

(54) METHOD AND APPARATUS FOR PRECISE ALIGNMENT ON A CONTINUOUS BELT DISC PRINTER

(76) Inventor: Walter Wafler, Pittsford, NY (US)

Correspondence Address: BROWN & MICHAELS, PC;400 M & T BANK BUILDING, 118 NORTH TIOGA ST, ITHACA, NY, 14850, US

(21) Appl. No.: 12/787,511

(22) Filed: May 26, 2010

Related U.S. Application Data
(60) Provisional application No. 61/181,075, filed on May 26, 2009.

(51) Int. Cl. B41J 2/01; B41F 17/00; B41L 3/08

(52) U.S. Cl. 347/104; 101/35; 101/486

(57) ABSTRACT

A continuous feed printer for printing on the surface of an object, such as a CD, a DVD or a Blu-Ray disc, wherein the continuous feed printer has a continuous loop belt, a feed mechanism for depositing the object onto the continuous loop belt, at least one pair of alignment elements located on the continuous loop belt, and an alignment device which urges the object into abutment with the alignment elements. After the object is aligned against the alignment elements it is printed in a printing zone.

### REFERENCE TO RELATED APPLICATIONS

This application claims one or more inventions which were disclosed in Provisional Application Number 61/181,075, filed May 26, 2009, entitled “METHOD FOR PRECISE ALIGNMENT ON A CONTINUOUS BELT CD PRINTER”. The benefit under 35 USC § 119(e) of the United States provisional application is hereby claimed, and the aforementioned application is hereby incorporated herein by reference.

### FIELD OF THE INVENTION

The invention pertains to a continuous feed transport printer. More particularly, the invention pertains to printing the surfaces of CD's, DVD's or Blu-Ray® discs in a high speed, continuous mode, printing operation.

### BACKGROUND OF THE INVENTION

Various devices print on rigid objects utilizing ink jet, digital imaging devices or traditional printing processes. Typically these devices require that objects to be printed be placed on some sort of transport that will convey the object under a series of print heads or print stations. Typically, loading objects requires the transport to pause to enable each object to be accurately aligned. Alternatively, the system must be designed with a very precise alignment system to ensure that objects to be printed are correctly registered (“aligned”). Many different systems are used to position objects. Older systems rely on pockets or recesses that accurately hold the object to be printed. This requires the insertion of the object into the recess prior to printing and the subsequent removal of the object after printing. Regardless of the process used, successful printing devices must provide for the accurate positioning of the object during the printing process.

One such device is described in U.S. Pat. No. 6,793,302. However, the drawback to this system is that an object, such as a digital disc, must be placed precisely into cutouts which require a locating device that frequently fails to consistently position the object. Once a disc is misplaced with respect to the cutout, the operation must be shut down until the disc can properly be repositioned by hand. This is very time consuming and results in obvious lost productivity.

A typical high speed continuous machine printer contains various modules, such as a feeder with an optional disc inspection station, a belt transport, a color print zone, a cure zone, a disc image inspection station and disc staking. High speed printing of discs or other rigid or semi rigid objects is a challenge as most printing systems require precise registration between the primary colors that form the desired colors. Typically the disc must be registered within ½ pixel in each direction and this registration must be maintained between the various colors. At 360 dpi, the maximum allowable “miss registration” is less than 40 microns between colors and less than 20 microns within an individual color. To accomplish this, it is necessary to grasp the object to be printed, whether a CD, DVD or Blu-Ray® disc (hereinafter collectively referred to as digital discs) and locate it precisely on a transport device capable of moving the object at process speeds with out the object moving. If an ink jet printer is used, no feature can be positioned above the surface of the object as these would destroy the print heads. The problem is to position the disc or object without stopping the transport or if the transport is stopped, to accelerate it back up to the desired production speed of the transport. During this acceleration process the disc cannot move. Otherwise the print position is compromised. If the transport is not stopped then the object to be printed has to be grasped and then accurately located for printing. One option is to physically contact the disc and measure its position, calculate the correction value, and then adjust the position of the disc to place it in the precise position for printing. These types of systems are typically expensive and complicated to design, implement and maintain.

Printing on digital discs poses an additional challenge because the opposite side of the disc to be printed contains the data and if scratched or otherwise damaged the data may be unreadable thereby rendering the disc worthless. Special care must be taken to insure that the surface isn't scratched or abraded.

### SUMMARY OF THE INVENTION

This invention is a high throughput continuous feed printer that precisely aligns, transports and prints on the surface of objects such as digital discs. This printer consists of a feed mechanism which places objects such as discs on a constantly moving continuous loop belt and a mechanism for precisely positioning each disc prior to printing. The belt carries the object under a series of print heads which prints the desired image on the surface of the object.

Locating a disc for accurate image placement is achieved through the use of sensors and upstanding pins attached to the belt. Each disc is placed onto the moving belt forward of these pins and is then gently swept back against the pins to align the discs in both the X and Y axes of the belt. The sequence of first placing each disc on the moving belt, then insuring the accurate positioning of the disc for printing on the surface of the disc insures the accurate printing of digital discs at high throughput production rates of speed.

### BRIEF DESCRIPTION OF THE DRAWINGS

FIG. 1 shows a side-view schematic of a continuous belt disc printer according to the invention.

FIG. 2 shows a top plan view of the continuous belt disc printer of the invention.

FIG. 3 shows a detailed side plan view of a resilient contact element as the object positioning embodiment of the continuous belt disc printer of the invention.

FIG. 4 shows a detailed top plan view of the resilient contact element as the positioning embodiment of the continuous belt disc printer of the invention.

FIG. 5 shows a detailed side plan view of an air jet as the disc positioning embodiment of the continuous belt disc printer of the invention.

FIG. 6 shows a detailed top plan view of an air jet as the disc positioning embodiment of the continuous belt disc printer of the invention.

FIG. 7 shows a detailed side plan view of a rotary contact element as the disc positioning embodiment of the continuous belt printer of the invention.

FIG. 8 shows a detailed top plan view of at least one rotary contact element as the disc positioning embodiment of the continuous belt printer of the invention.

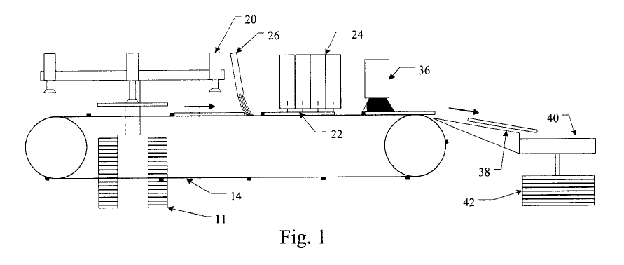

### DETAILED DESCRIPTION OF THE INVENTION

In accordance with the invention, an object such as a digital disc 10 is removed from one of a plurality of supply stacks, or spindles, 11 and is placed by a high speed feed device onto a moving belt 14. Pairs of alignment elements, such as registration pins 18, are positioned at predetermined distances between each other along the belt 14. Each disc 10 is gently swept back against a pair of alignment pins 18 by an alignment device.

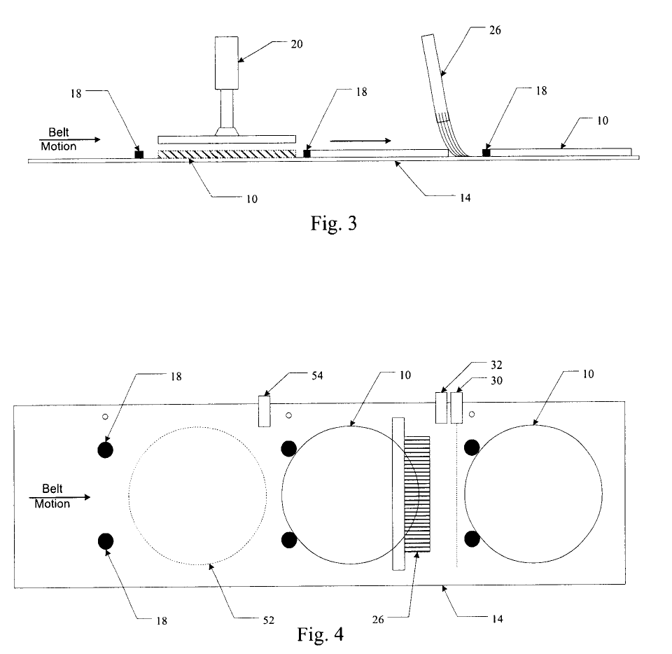

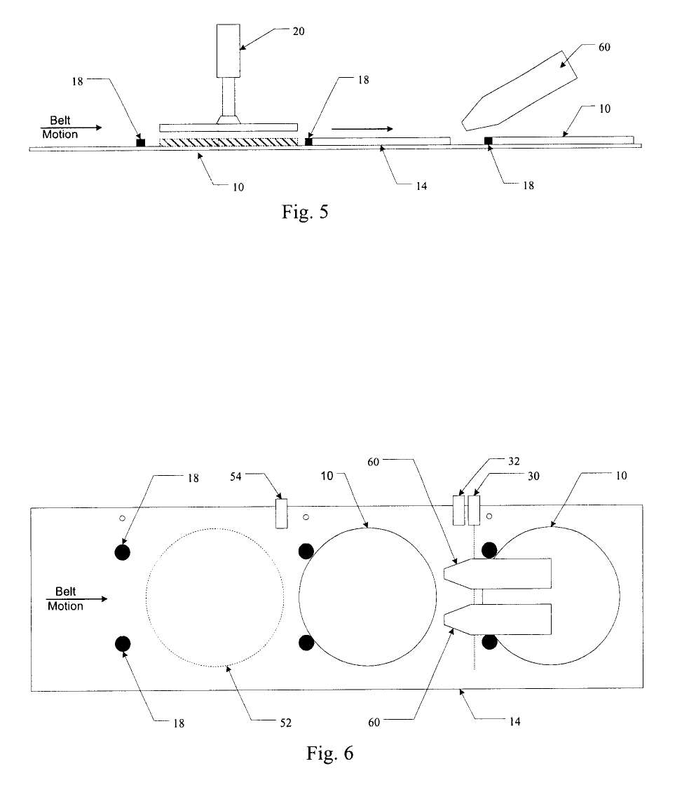

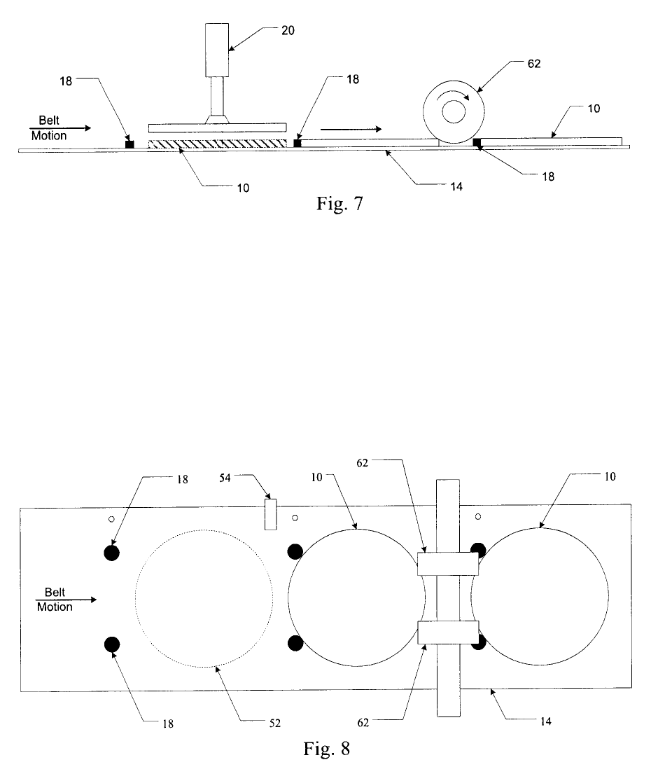

The alignment device must contact the digital disc 10 with very low pressure, so as to not damage the delicate disc. Examples of such alignment devices include an air jet 60, as shown in FIGS. 5 and 6, a resilient contact element 26, which includes fine, soft bristled brush fibers, soft plastic or rubber contacts, as shown in FIGS. 3 and 4 and a rotary contact element 62, as shown in FIGS. 7 and 8. The rotary contact element consists of either fine, soft bristled brush fibers, soft plastic or rubber contacts.

Unprinted discs are contained on one or more spindles 11 where multiple discs 10 may be stacked on a single spindle 11. An air actuated vacuum feeder 20 on an end of an arm of a rotary feeder 12 grips an individual disc 10 from a spindle 11, and rotates to transport the disc 11.

Once the disc is gripped by the vacuum feeder 20, the disc 10 is lifted off the spindle 11, the rotary feeder 12 rotates to index the disc 10 to a position either directly over the belt 14 or to an inspection station, generally designated as 50. The inspection station 50 reads a code that identifies the contents of the disc 10 to determine if the correct disc is to be printed or to match the print image to the correct disc. Once the disc 10 has been inspected, if necessary, the rotary feeder 12 rotates to position the disc 10 over the belt 14.

The belt 14 is continually moving in a direction of travel. The vacuum feeder 20 is synchronized with the movement of the belt 14 by passage of a timing mark past position sensor 32, located adjacent to the belt 14. By use of a delay, as an individual disc arrives over a position forward of a pair of registration pins 18, designated as the targeted landing area 52, the vacuum is released from the vacuum feeder 20 to drop the disc 10 on the belt. The exact position of the disc 10 relative to the pins 18 is not critical at this time.

The disc 10 travels on the belt in the direction of belt travel from the targeted landing area 52, until it reaches the alignment device, which gently urges the disc 10 into abutment with each one of the pair of registration pins 18 behind the disc. This insures proper alignment of the disc with respect to the X axis, or longitudinal axis of the belt 14, and the Y axis, which is perpendicular to the longitudinal axis of the belt 14.

The disc 10, now properly positioned against the registration pins 18, passes by a position sensor 32 and a timing sensor 30. The position sensor 32 determines that the disc is about to enter the printer zone 22, and the timing sensor 30 determines that the disc is oriented properly for printing.

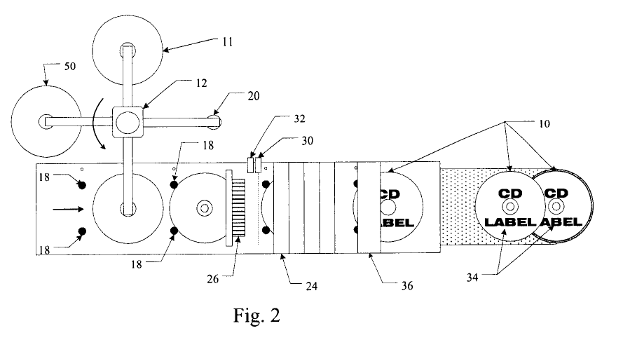

The printer zone 22 has a printing mechanism, for example an inkjet printer mechanism which could be single-color or can have a variety of different color stations or cartridges. As shown in the exemplary embodiment represented in FIG. 2, the designations “B”, “C”, “M” and “Y” indicate the stations for printing colors black, cyan, magenta and yellow. In this embodiment, each of the multiple color stations of the printer zone 22 have an inkjet print head that prints the desired label information and/or design 34 on the surface of each disc 10. The print head can be a traveling head which sweeps across the belt, or a fixed, full-width head extending across the entire width of the belt.

One skilled in the art would recognize that while this description and drawing has shown an inkjet mechanism for exemplary purposes, other printing mechanisms known to the art could be used within the teachings of the invention.

After each disc 10 is printed, if required, it may pass into a curing section 36. Since UV print ink is preferred, the curing section 36 is specifically designed to cure UV ink.

However, other print processes may be used, which might require different drying or curing devices, and with some inks the curing or drying section can be omitted entirely.

Afterward, the belt 14 continues to carry the disc 10 with the dried label or design 34 and deposits it onto a transport 38 where a disc stacker 40 aligns and deposits the finished disc 10 into a finished disc stack 42.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A continuous feed printer for printing on the surface of an object, comprising a continuous loop belt having an upper surface moving in a direction of travel, a targeted landing area, and a print zone spaced apart from the targeted landing area in the direction of travel of the upper surface comprising:
a) at least one pair of alignment elements located on the continuous loop belt;
b) a feed mechanism for depositing the object onto the upper surface of the continuous loop belt at the targeted landing area;
c) an alignment device between the targeted landing area and the print zone, for urging the object into abutment with the at least one pair of alignment elements; and
d) a print mechanism for printing on the object, located in the print zone.

2. The continuous feed printer of claim 1, further comprising an alignment sensor for determining a location of an object deposited on the continuous loop belt by the feed mechanism, located adjacent to the upper surface of the continuous loop belt between the targeted landing area and the alignment device.

3. The continuous feed printer of claim 1, further comprising a position sensor for determining that an object on the upper surface of the belt is about to enter the print zone, located adjacent to the upper surface of the continuous loop belt between the alignment device and the print zone.

4. The continuous feed printer of claim 1, further comprising a timing sensor for determining that the object on the upper surface of the belt is in proper orientation for printing, located adjacent to the upper surface of the continuous loop belt between the alignment device and the print zone.

5. The continuous feed printer of claim 1 wherein the object is a digital disc.

6. The continuous feed printer of claim 1 wherein the alignment device is an air jet.

7. The continuous feed printer of claim 1 wherein the alignment device is a brush.

8. The continuous feed printer of claim 1 wherein the alignment device is a resilient contact element.

9. The continuous feed printer of claim 1 wherein the alignment device aligns the object in both X and Y planes on the continuous loop belt.

10. The continuous feed printer of claim 1 in which the print mechanism comprises an inkjet printer.

11. The continuous feed printer of claim 1, in which the print mechanism comprises a plurality of color stations.

12. The continuous feed printer of claim 1, in which the alignment elements are registration pins.

13. A method of printing on objects using a printer comprising a continuous loop belt having an upper surface moving in a direction of travel, a targeted landing area on the upper surface, at least one pair of alignment elements located on the continuous loop belt and a print zone spaced apart from the targeted landing area in the direction of travel of the upper surface, the method comprising:
a) positioning an object on the targeted landing area forward of the at least one pair of alignment elements;
b) aligning the object by urging it against the at least one pair of alignment elements with an alignment device; and
c) printing on the object with the print mechanism.

14. The method of claim 13, further comprising determining that an object on the upper surface of the belt is about to enter the print zone using a position sensor located adjacent to the upper surface of the continuous loop belt between the alignment device and the print zone.

15. The method of claim 13 further comprising determining that the object on the upper surface of the belt is in proper orientation for printing using a timing sensor located adjacent to the upper surface of the continuous loop belt between the alignment device and the print zone.

16. The method of claim 13 wherein the alignment device is a brush.

17. The method of claim 13 wherein the alignment device is a resilient contact element.

18. The method of claim 13 wherein the alignment device is an air jet.

19. The method of claim 13 wherein the step of printing is done by an inkjet printer.

20. The method of claim 13 wherein the step of printing comprises printing a plurality of colors at a plurality of color stations.
